(19) United States
(12) Patent Application Publication
(10) Pub. No.: US 2010/0324876 A1
(43) Pub. Date: Dec. 23, 2010

(54) SIMULATION METHOD FOR A WIRELESS COMMUNICATION SYSTEM INCLUDING MULTIPLE ANTENNAS AND MULTIPLE NODES

(75) Inventors: Cheng Hsuan Wu, HSINCHU COUNTY (TW); Chun Hsien Wen, HSINCHU COUNTY (TW); Jiunn Tsair Chen, HSINCHU COUNTY (TW)

Correspondence Address: HAMRE, SCHUMANN, MUELLER & LARSON, P.C., P.O. BOX 2902, MINNEAPOLIS, MN, 55402-0902, US

(73) Assignee: RALINK TECHNOLOGY CORPORATION, HSINCHU COUNTY (TW)

(21) Appl. No.: 12/643,815

(22) Filed: Dec. 21, 2009

(30) Foreign Application Priority Data
Jun. 22, 2009 (TW) 098120776

(51) Int. Cl. G06F 17/50

(52) U.S. Cl. 703/13

(57) ABSTRACT

A simulation method for a wireless communication system with multiple antennas and multiple nodes is disclosed. The method adopts a separable correlation channel model to simulate a wireless communication system with multiple antennas and multiple nodes, wherein in this model the nodes in the same area are correlated, and the nodes in different areas are not correlated.

### BACKGROUND OF THE INVENTION

1. Field of the Invention

The present invention relates to a simulation method of a wireless communication system, and more particularly, to a simulation method of a wireless communication system including multiple antennas and multiple nodes.

2. Description of the Related Art

In a conventional wireless communication system, the transmitting end transmits signals and the receiving end receives signals by a single antenna respectively. With improvements in manufacturing processes of integrated circuits and the development of a variety of communication theory algorithms, the transmitting end that transmits signals and the receiving end that receives signals by multiple antennas respectively are well accepted by the market. Compared with single-antenna signal transmitting devices, multiple-antenna signal transmitting devices exhibit higher throughput and longer transmission distance without additional bandwidth or energy due to better spatial diversity. Therefore, the majority of wireless communication devices are now multiple-antenna signal transmitting devices.

Meanwhile, when designing a wireless communication system, a channel model is often required to simulate the real transmission environment such that the designed wireless communication system can be inspected according to the channel model run on a computer. Accordingly, the transmission efficiency of the wireless communication system can be evaluated. Traditional node-to-node channel models for multiple-antenna signal transmitting devices assume the channel between the transmitting end and the receiving end is a Rayleigh fading channel, and all of the channels between each antenna at the transmitting end and each antenna at the receiving end are also assumed to be independent Rayleigh fading channels. However, the aforementioned channel models cannot simulate the real transmission environment well. In addition, the performance of the wireless communication system is difficult to evaluate due to the fact that each independent Rayleigh fading channel is generated randomly.

Accordingly, modern node-to-node channel models for multiple-antenna signal transmitting devices adopt separable correlation channel models which can be represented by the following matrix equation: C=R^{1/2}*W*T^{1/2}, wherein C represents the channel, R represents a correlation matrix of each antenna at the receiving end, T represents a correlation matrix of each antenna at the transmitting end and W represents an identically and independently distributed Rayleigh fading matrix. FIG. 1 shows a node-to-node separable correlation channel model for a multiple-antenna signal transmitting device. As shown in FIG. 1, a multiple-antenna signal transmitting device 110 is used as a transmitting end, and another multiple-antenna signal transmitting device 120 is used as a receiving end. The transmitting end 110 transmits a signal through a channel 130 to the receiving end 120. The transmitting end 110 comprises a plurality of antennas M₁ to M_{T}. The receiving end 120 comprises a plurality of antennas N₁ to N_{R}. The correlation matrix of the antennas M₁ to M_{T} is T. The correlation matrix of the antennas N₁ to N_{R} is R. The channel 130 can be represented by the following matrix equation: C=R″*W*T^{1/2}, wherein C represents the channel and W represents an identically and independently distributed Rayleigh fading matrix. Compared with the traditional node-to-node channel models for multiple-antenna signal transmitting devices, the channel model shown in FIG. 1 is much more suitable for the simulation of the real transmission environment, and therefore is widely used in industry.

With the development of wireless communication technology, traditional node-to-node wireless communication systems can no longer provide a suitable communication environment for the industry. Multiple-user or multiple-node communication networks are becoming a promising technology. However, there is no channel model existing to evaluate the multiple-node wireless communication system. Therefore, there is a need to design a simulation method for a wireless communication system of a multiple-antenna and multiple-node environment such that the variables are easy to control and the channel model accurately simulates the real communication system.

### SUMMARY OF THE INVENTION

The simulation method for a wireless communication system with multiple antennas and multiple nodes of the present invention adopts a separable correlation channel model to simulate a wireless communication system with multiple antennas and multiple nodes, wherein in this model the nodes in the same area are correlated, and the nodes in different areas are not correlated.

The simulation method for a wireless communication system of a multiple-antenna and multiple-node environment according to one embodiment of the present invention comprises the step of simulating a wireless communication system based on a channel model. The channel model can be described as C=R^{1/2}*W*T^{1/2}, wherein C represents the channel, R represents the covariance matrix of each antenna of each node at a receiving end, represents the covariance matrix of each antenna of each node at a transmitting end and W represents an identically and independently distributed Rayleigh fading matrix. The covariance matrix R can be represented by the following matrix:

$$R * {R}^{H} = [ \begin{matrix}{R}_{11} & \cdot & \cdot & … & \cdot & \cdot & \cdot \\ \cdot & {R}_{22} & \cdot & … & \cdot & \cdot & \cdot \\ \cdot & \cdot & {R}_{33} & … & \cdot & \cdot & \cdot \\ ⋮ & ⋮ & ⋮ & ⋱ & ⋮ & ⋮ & ⋮ \\ \cdot & \cdot & \cdot & … & {R}_{( n - 2 ) ( n - 2 )} & \cdot & \cdot \\ \cdot & \cdot & \cdot & … & \cdot & {R}_{( n - 1 ) ( n - 1 )} & \cdot \\ \cdot & \cdot & \cdot & … & \cdot & \cdot & {R}_{nn}\end{matrix} ] ,$$

wherein each entry represents a sub-matrix, H represents the Hermitian operation, and Rᵢᵢ represents the covariance matrix of the antennas of the i^{th} node. If the j^{th} node and the k^{th} node at the receiving end are in different areas, the sub-matrixes represented by the entries at the j^{th} column, the k^{th} row and the k^{th} column, the j^{th} row of the matrix R*R^{H} are all-zero matrixes.

The simulation method for a wireless communication system of a multiple-antenna and multiple-node environment according to another embodiment of the present invention comprises the steps of generating a transmitting signal according to a transmitting end model; inputting or to providing the transmitting signal into a channel model to obtain a channel-passing signal; inputting or providing the channel-passing signal into a receiving end model to obtain a receiving signal; and adjusting the transmitting end model or the receiving end model according to the receiving signal. The channel model comprises a covariance matrix R, a covariance matrix T and a channel C. The covariance matrix R represents covariance of each antenna of each node at the receiving end. The covariance matrix T represents covariance of each antenna of each node at the transmitting end. The channel C can be represented by C=R^{1/2}*W*T^{1/2}, wherein W represents an identically and independently distributed Rayleigh fading matrix. The covariance matrix R can be represented by the following matrix:

$$R * {R}^{H} = [ \begin{matrix}{R}_{11} & \cdot & \cdot & … & \cdot & \cdot & \cdot \\ \cdot & {R}_{22} & \cdot & … & \cdot & \cdot & \cdot \\ \cdot & \cdot & {R}_{33} & … & \cdot & \cdot & \cdot \\ ⋮ & ⋮ & ⋮ & ⋱ & ⋮ & ⋮ & ⋮ \\ \cdot & \cdot & \cdot & … & {R}_{( n - 2 ) ( n - 2 )} & \cdot & \cdot \\ \cdot & \cdot & \cdot & … & \cdot & {R}_{( n - 1 ) ( n - 1 )} & \cdot \\ \cdot & \cdot & \cdot & … & \cdot & \cdot & {R}_{nn}\end{matrix} ] ,$$

wherein each entry represents a sub-matrix, H represents the Hermitian operation, and Rᵢᵢ represents the covariance matrix of the antennas of the i^{th} node. If the j^{th} node and the k^{th} node at the receiving end are in different areas, the sub-matrixes represented by the entries at the j^{th} column, the k^{th} row and the k^{th column, the j}^{th} row of the matrix R*R^{H} are all-zero matrixes.

### BRIEF DESCRIPTION OF THE DRAWINGS

The objectives and advantages of the present invention will become apparent upon reading the following description and upon referring to the accompanying drawings of which:

FIG. 1 shows a conventional node-to-node separable correlation channel model for a multiple-antenna signal transmitting device;

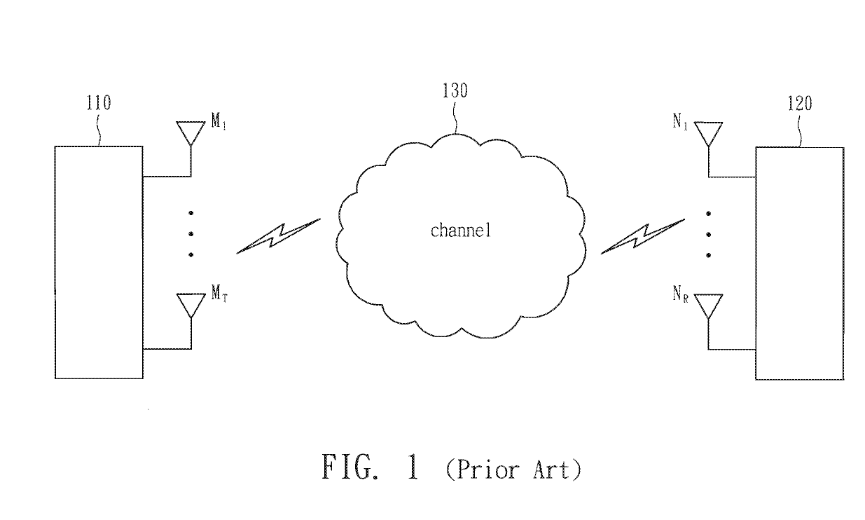

FIG. 2 shows the flow chart of a simulation method for a wireless communication system of a multiple-antenna and multiple-node environment according to an embodiment of the present invention;

FIG. 3 shows the flow chart of a simulation method for a wireless communication system of a multiple-antenna and multiple-node environment according to another embodiment of the present invention;

FIG. 4 shows a wireless communication system of a multiple-antenna and multiple-node environment according to an embodiment of the present invention;

FIG. 5 shows a separable correlation channel model of the wireless communication system of a multiple-antenna and multiple-node environment according to an embodiment of the present invention;

FIG. 6 shows the covariance matrix R of the antennas of the nodes at a receiving end according to an embodiment of the present invention; and

FIG. 7 shows the covariance matrix R′ of the antennas of the nodes at a receiving end according to another embodiment of the present invention.

### DETAILED DESCRIPTION OF THE INVENTION

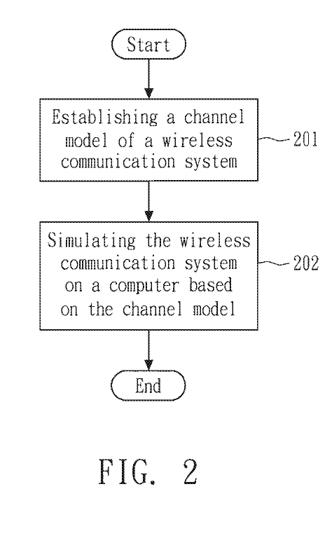

FIG. 2 shows the flow chart of a simulation method for a wireless communication system of a multiple-antenna and multiple-node environment according to an embodiment of the present invention. In step 201, a channel model of a wireless communication system is established, and step 202 is executed. In step 202, the wireless communication system is simulated on a computer based on the channel model. The channel model can be represented by the following matrix equation: C=R^{1/2}*W*T^{1/2}, wherein C represents the channel, R represents a covariance matrix of each antenna of each node at a receiving end, T represents a covariance matrix of each antenna of each node at a transmitting end, W represents an identically and independently distributed Rayleigh fading matrix, and R can be to represented by the following matrix:

$$R * {R}^{H} = [ \begin{matrix}{R}_{11} & \cdot & \cdot & … & \cdot & \cdot & \cdot \\ \cdot & {R}_{22} & \cdot & … & \cdot & \cdot & \cdot \\ \cdot & \cdot & {R}_{33} & … & \cdot & \cdot & \cdot \\ ⋮ & ⋮ & ⋮ & ⋱ & ⋮ & ⋮ & ⋮ \\ \cdot & \cdot & \cdot & … & {R}_{( n - 2 ) ( n - 2 )} & \cdot & \cdot \\ \cdot & \cdot & \cdot & … & \cdot & {R}_{( n - 1 ) ( n - 1 )} & \cdot \\ \cdot & \cdot & \cdot & … & \cdot & \cdot & {R}_{nn}\end{matrix} ] ,$$

wherein each entry represents a sub-matrix, H represents the Hermitian operation, and Rᵢᵢ represents the covariance matrix of the antennas of the i^{th} node. If the j^{th} node and the k^{th} node at the receiving end are in different areas, the sub-matrixes represented by the entries at the j^{th} column, the k^{th} row and the k^{th} column, the j^{th} row of the matrix R*R^{H} are all-zero matrixes. If the j^{th} node and the k^{th} node at the receiving end are in the same area, the sub-matrixes Rⱼⱼ, Rₖₖ and the sub-matrixes represented by the entries at the j^{th} column and the k^{th} row and the k^{th} column and the j^{th} row of the matrix R*R^{H} can be represented as

$$[ \begin{matrix}{R}_{jj} & {R}_{kj} \\ {R}_{jk} & {R}_{kk}\end{matrix} ] = [ \begin{matrix}{R}_{j} {R}_{j}^{H} & 0 \\ 0 & {R}_{k} {R}_{k}^{H}\end{matrix} ] + [ \begin{matrix}\sqrt{{KK}^{H}} & K \\ K & \sqrt{{K}^{H} K}\end{matrix} ] ,$$

wherein Rⱼₖ and Rₖⱼ each represents the sub-matrixes represented by the entries at the j^{th} column, the k^{th} row and the k^{th} column, the j^{th} row of the matrix R*R^{H} respectively, Rᵢ; represents a correlation matrix between the antennas of the i^{th} node at the receiving end, 0 represents an all-zero matrix and K represents a matrix resulting from multiplying an all-one matrix with a phase-shifting matrix.

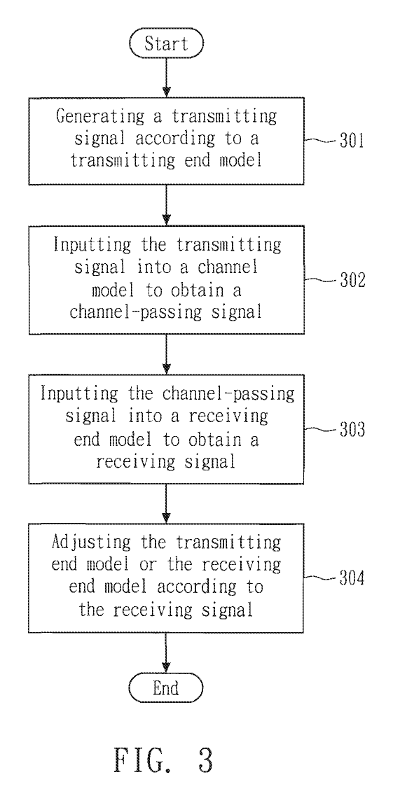

FIG. 3 shows the flow chart of a simulation method for a wireless communication system of a multiple-antenna and multiple-node environment according to another embodiment of the present invention. In step 301, a transmitting signal is generated according to a transmitting end model, and step 302 is executed. In step 302, the transmitting signal is input into a channel model to obtain a channel-passing signal, and step 303 is executed. In step 303, the channel-passing signal is input into a receiving end model to obtain a receiving signal, and step 304 is executed. In step 304, the transmitting end model or the receiving end model is adjusted according to the receiving signal. The adopted channel model is similar to the channel model shown in the embodiment of FIG. 2 and therefore can similarly be represented by the following matrix equation: C=R^{1/2}*W*T^{1/2}.

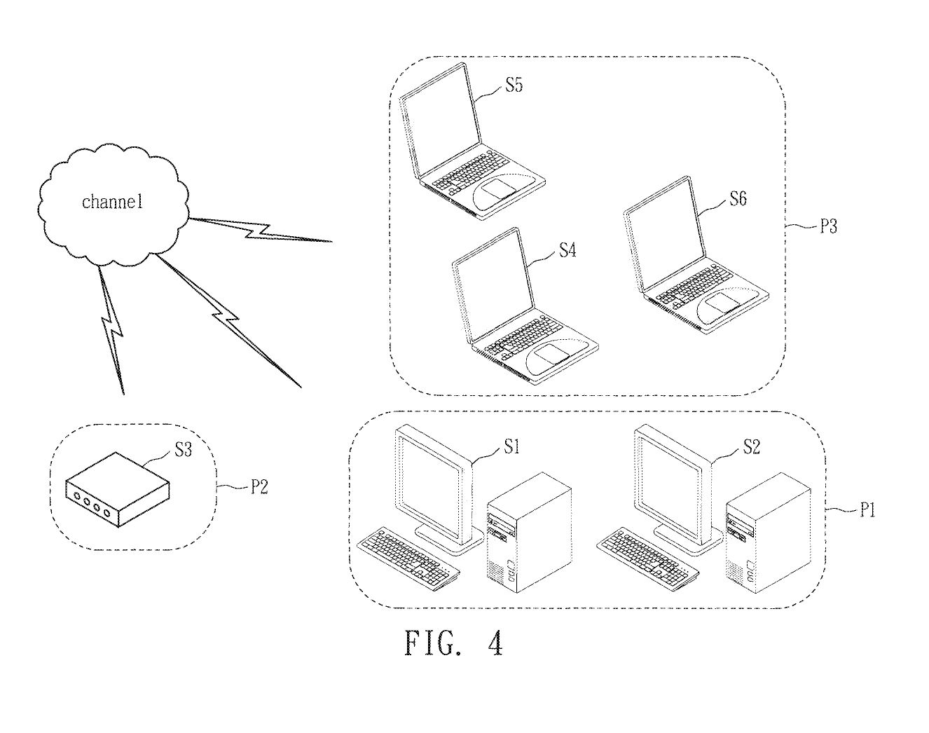

FIG. 4 shows a wireless communication system of a multiple-antenna and multiple-node environment. As shown in FIG. 4, the wireless communication system 300 is an indoor wireless communication system, comprising three personal local area networks P1, P2 and P3. The personal local area network P1 comprises two nodes, or users, S1 and S2. The personal local area network P2 comprises one node S3. The personal local area network P3 comprises three nodes, or users, S4, S5 and S6. In this embodiment, the nodes in the same confined space, such as a room in a house, are regarded as being in the same personal local area network.

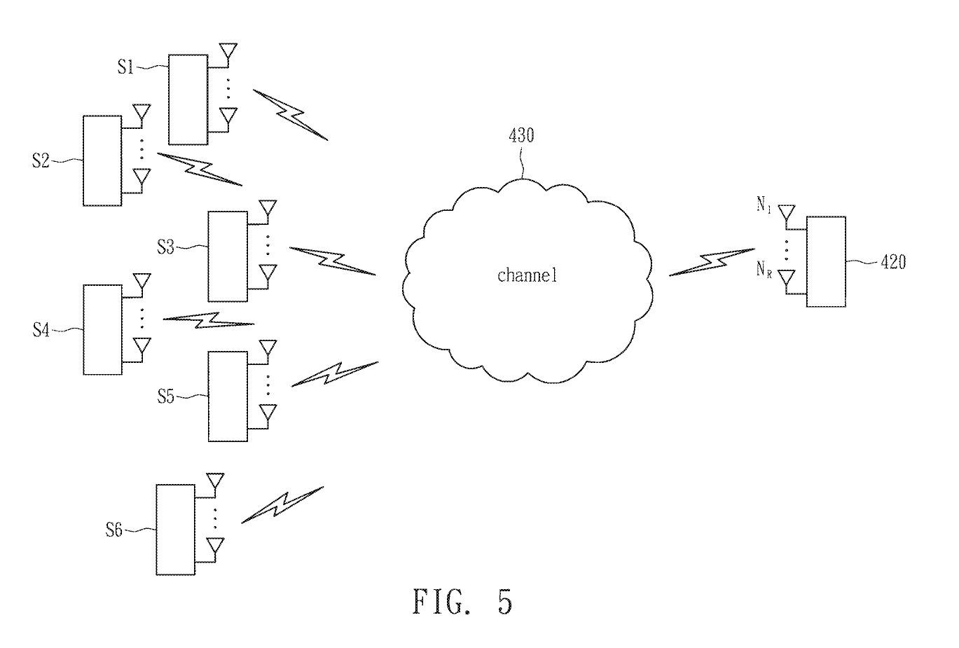

If the nodes S1 to S6 are used as receiving ends, then the simulation method for a wireless communication system of a multiple-antenna and multiple-node environment according to the embodiments of the present invention can be applied to the wireless communication system shown in FIG. 4. Assume that the nodes in the same personal local area network are correlated, and the nodes in different personal local area networks are not correlated due to the distance or shielding effect. FIG. 5 shows a separable correlation channel model of the wireless communication system of a multiple-antenna and multiple-node environment shown in FIG. 4. As shown in FIG. 5, the nodes S1 to S6 are used as receiving ends, and receive signals through a channel 430 from a transmitting end 420. Each of the nodes S1 to S6 comprises a plurality of antennas. The covariance matrix of the antennas is R. The transmitting end 420 also comprises a plurality of antennas N₁ to N_{R}. The covariance matrix of the antennas N₁ to N_{R} is T. The channel 430 can be represented by the following matrix equation: C=R^{1/2}*W*T^{1/2}, wherein W represents an identically and independently distributed Rayleigh fading matrix.

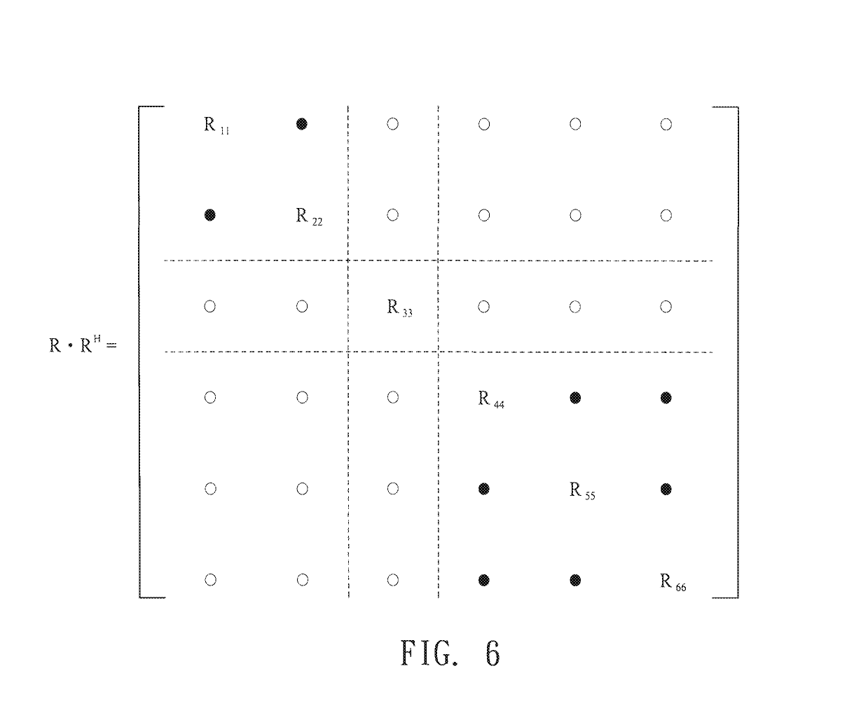

FIG. 6 shows the covariance matrix R of the antennas of the nodes S1 to S6. As shown in FIG. 6, R₁₁ to R₆₆ represent the covariance matrixes of the nodes S1 to S6, respectively. For the nodes in different personal local area networks, such as S2 and S3, the corresponding covariance matrix is an all-zero matrix since they are not correlated. Therefore, as shown in FIG. 6, the entries represented by the hollow dots are all all-zero matrixes.

On the other hand, the nodes in the same personal local area network, such as S1 and S2, are correlated. Therefore, the covariance matrix of S1 and S2 can be divided into a first part concerning the individual parts belonging to only one node, S1 or S2, (such as energies from different diffraction sources) and a second part concerning the shared parts of both of the nodes S1 and S2 (such as energies from the same diffraction source). In this embodiment, the covariance matrix of S1 and S2 can be represented by the following matrix equation:

$$[ \begin{matrix}{R}_{1} {R}_{1}^{H} & 0 \\ 0 & {R}_{2} {R}_{2}^{H}\end{matrix} ] + [ \begin{matrix}\sqrt{{KK}^{H}} & K \\ K & \sqrt{{K}^{H} K}\end{matrix} ] ,$$

wherein R₁ and R₂ represent the correlation matrixes of the nodes S1 and S2 respectively and K represents a matrix resulting from multiplying an all-one matrix with a phase-shifting matrix.

The following equation exemplifies the values of the covariance matrix R shown in FIG. 6. If all of the nodes S1 to S6 are double-antenna signal transmitting devices, the correlation matrixes of the nodes S1 to S6 can be represented as follows:

$${R}_{1} = [ \begin{matrix}1 & - 0.47 - 0.73 j \\ - 0.47 + 0.73 j & 1\end{matrix} ] , \\ {R}_{2} = [ \begin{matrix}1 & - 0.52 + 0.19 j \\ - 0.52 - 0.19 j & 1\end{matrix} ] , \\ {R}_{3} = [ \begin{matrix}1 & 0.71 - 0.13 j \\ 0.71 + 0.13 j & 1\end{matrix} ] , \\ {R}_{4} = [ \begin{matrix}1 & - 0.27 - 0.33 j \\ - 0.27 + 0.33 j & 1\end{matrix} ]$$

$${R}_{5} = [ \begin{matrix}1 & - 0.52 + 0.19 j \\ - 0.52 - 0.19 j & 1\end{matrix} ] and$$

$${R}_{6} = [ \begin{matrix}1 & - 0.52 + 0.19 j \\ - 0.52 - 0.19 j & 1\end{matrix} ] .$$

The covariance matrix of S1 and S2 can be represented as follows:

$$[ \begin{matrix}{R}_{1} {R}_{1}^{H} & 0 \\ 0 & {R}_{2} {R}_{2}^{H}\end{matrix} ] + [ \begin{matrix}\sqrt{{KK}^{H}} & K \\ K & \sqrt{{K}^{H} K}\end{matrix} ] = [ \begin{matrix}1.75 & - 0.94 - 1.46 j & 0 & 0 \\ - 0.94 + 1.46 j & 1.75 & 0 & 0 \\ 0 & 0 & 1.3 & - 1.04 + 0.38 j \\ 0 & 0 & - 1.04 - 0.38 j & 1.3\end{matrix} ] + [ \begin{matrix}1.41 & 0.41 - 1.25 j & 0.4 + 0.91 j & 0.988 + 0.14 j \\ 0.41 + 1.25 j & 1.41 & - 0.53 - 0.84 j & - 0.54 + 0.83 j \\ 0.4 + 0.91 j & 0.988 + 0.14 j & 1.41 & 0.96 - 0.9 j \\ - 0.53 - 0.84 j & - 0.54 + 0.83 j & 0.96 + 0.9 j & 1.41\end{matrix} ] = [ \begin{matrix}3.16 & - 0.52 - 2.71 j & 0.4 + 0.91 j & 0.988 + 0.14 j \\ - 0.52 + 2.71 j & 3.16 & - 0.53 - 0.84 j & - 0.54 + 0.83 j \\ 0.4 + 0.91 j & 0.988 + 0.14 j & 2.72 & 0.07 - 0.52 j \\ - 0.53 - 0.84 j & - 0.54 + 0.83 j & 0.07 + 0.52 j & 2.72\end{matrix} ] .$$

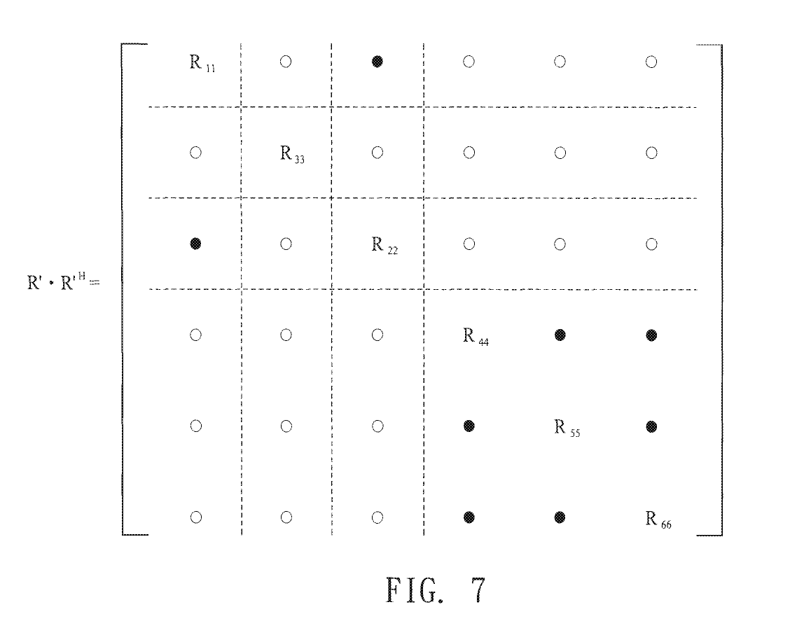

It should be noted that the order of the entries of the covariance matrix R representing each antenna of each node at a receiving end of the simulation method for a wireless communication system of a multiple-antenna and multiple-node environment according to the embodiments of the present invention can be rearranged and still be covered by the present invention, as long as the rearranged covariance matrix R′ meets its limitation. FIG. 7 shows a covariance matrix R′, a variance of the covariance matrix R shown in FIG. 6.

In conclusion, the simulation method for a wireless communication system of a multiple-antenna and multiple-node environment of the present invention adopts a separable correlation channel model to simulate a wireless communication system with multiple antennas and multiple nodes. Accordingly, not only does the channel model exhibit a corresponding physical meaning such that it accurately simulates the real communication environment, but the generation of the channel is also easy, and the variables thereof are fairly controllable.

The above-described embodiments of the present invention are intended to be illustrative only. Those skilled in the art may devise numerous alternative embodiments without departing from the scope of the following claims.

What is claimed is:

1. A simulation method for a wireless communication system including multiple antennas and multiple nodes, comprising the steps of:
simulating the wireless communication system based on a channel model, the channel model being represented as C=R^{1/2}*W*T^{1/2};
wherein C represents a channel, R represents a covariance matrix of each antenna of each node at a receiving end, T represents a covariance matrix of each antenna of each node at a transmitting end, W represents an identically and independently distributed Rayleigh fading matrix, and a to matrix X resulting from multiplying the matrix R with R^{H} comprises n rows and n columns;
wherein each entry of the matrix X is a sub-matrix, H represents a Hermitian operation, n is the number of nodes at the receiving end, an entry at the column, the i^{th} row of the matrix X represents a covariance matrix between each antenna of the i^{th} node at the receiving end, and if the j^{th} node and k^{th} node at the receiving end are in different areas, the sub-matrixes represented by entries at the j^{th} column, the k^{th} row and the k^{th} column, the j^{th} row of the matrix X are all-zero matrixes, wherein i, j and k are integers not greater than n.

2. The simulation method of claim 1, wherein if the j^{th} node and the k^{th} node at the receiving end are in the same area, the sub-matrixes Rⱼⱼ, Rₖₖ and the sub-matrixes represented by entries at the j^{th} column, the k^{th} row and the k^{th} column, the j^{th} row of a matrix R*R^{H} are represented as:
$$[ \begin{matrix}{R}_{jj} & {R}_{kj} \\ {R}_{jk} & {R}_{kk}\end{matrix} ] = [ \begin{matrix}{R}_{j} {R}_{j}^{H} & 0 \\ 0 & {R}_{k} {R}_{k}^{H}\end{matrix} ] + [ \begin{matrix}\sqrt{{KK}^{H}} & K \\ K & \sqrt{{K}^{H} K}\end{matrix} ] ,$$
wherein Rⱼₖ and Rₖⱼ each represents the sub-matrixes represented by entries at the j^{th} column, the k^{th} row and the k^{th} column, the j^{th} row of the matrix R*R^{H} respectively, Rᵢ represents a correlation matrix between the antennas of the node at the receiving end, 0 represents an all-zero matrix and K represents a matrix resulting from multiplying an all-one matrix with a phase-shifting matrix.

3. The simulation method of claim 1, wherein the wireless communication system is an indoor wireless communication system.

4. The simulation method of claim 1, wherein the nodes in a same confined space are regarded as being in the same area.

5. The simulation method of claim 1, wherein the nodes in a same personal local area network are regarded as being in the same area.

6. A simulation method for a wireless communication system including multiple antennas and multiple nodes, comprising the steps of:
representing covariance of each antenna of each node at a receiving end by a covariance matrix R;
representing covariance of each antenna of each node at a transmitting end by a covariance matrix T;
representing a channel C with C=R^{1/2}*W*T^{1/2}, wherein W represents an identically and independently distributed Rayleigh fading matrix;
wherein a matrix X resulting from multiplying the matrix R with R^{H} comprises n rows and n columns, each entry of the matrix X is a sub-matrix, H represents a Hermitian operation, n is the number of nodes at the receiving end, an entry at the i^{th} column, the i^{th} row of the matrix X represents the covariance matrix between each antenna of the i^{th} node at the receiving end, and if the j^{th} node and the k^{th} node at the receiving end are in different areas, the sub-matrixes represented by entries at the j^{th} column, the k^{th} row and the k^{th} column, the j^{th} row of the matrix X are all-zero matrixes, wherein i, j and k are integers not greater than n.

7. The simulation method of claim 6, if the j^{th} node and the k^{th} node at the receiving end are in the same area, the sub-matrixes Rⱼⱼ, Rₖₖ and the sub-matrixes represented by the entries at the j^{th} column, the k^{th} row and the k^{th} column, the j^{th} row of the matrix R*R^{H} are represented as:
$$[ \begin{matrix}{R}_{jj} & {R}_{kj} \\ {R}_{jk} & {R}_{kk}\end{matrix} ] = [ \begin{matrix}{R}_{j} {R}_{j}^{H} & 0 \\ 0 & {R}_{k} {R}_{k}^{H}\end{matrix} ] + [ \begin{matrix}\sqrt{{KK}^{H}} & K \\ K & \sqrt{{K}^{H} K}\end{matrix} ] ,$$
wherein Rⱼₖ and Rₖⱼ each represents the sub-matrixes represented by entries at the j^{th} column, the k^{th} row and the k^{th} column, the j^{th} row of the matrix R*R^{H} respectively, Rᵢ represents a correlation matrix between antennas of the i^{th} node at the receiving end, 0 represents an all-zero matrix and K represents a matrix resulting from multiplying an all-one matrix with a phase-shifting matrix.

8. The simulation method of claim 6, wherein the wireless communication system is an indoor wireless communication system.

9. The simulation method of claim 6, wherein the nodes in a same confined space are regarded as being in the same area.

10. The simulation method of claim 6, wherein the nodes in a same personal local area network are regarded as being in the same area.

11. A simulation method for a wireless communication system including multiple antennas and multiple nodes, comprising the steps of:
generating a transmitting signal according to a transmitting end model;
providing the transmitting signal to a channel model to obtain a channel-passing signal;
providing the channel-passing signal to a receiving end model to obtain a receiving signal;
adjusting the transmitting end model or the receiving end model according to the receiving signal;
wherein the channel model comprises:
a covariance matrix R, representing covariance of each antenna of each node at the receiving end;
a covariance matrix T, representing covariance of each antenna of each node at the transmitting end; and
a channel C, represented by C=R^{1/2}*W*T^{1/2}, wherein W represents an identically and independently distributed Rayleigh fading matrix;
wherein a matrix X resulting from multiplying the matrix R with R^{H} comprises n rows and n columns, each entry of the matrix X is a sub-matrix, H represents a Hermitian operation, n is the number of nodes at the receiving end, an entry at the i^{th} column, the i^{th} row of the matrix X represents the covariance matrix between each antenna of the node at the receiving end, and if the j^{th} node and the k^{th} node at the receiving end are in different areas, the sub-matrixes represented by entries at the j^{th} column, the k^{th} row and the k^{th} column, the j^{th} row of the matrix X are all-zero matrixes, wherein i, j and k are integers not greater than n.

12. The simulation method of claim 11, wherein if the j^{th} node and the k^{th} node at the receiving end are in the same area, the sub-matrixes Rⱼⱼ, Rₖₖ and the sub-matrixes represented by entries at the j^{th} column, the k^{th} row and the k^{th} column, the j^{th} row of the matrix R*R^{H} are represented as:
$$[ \begin{matrix}{R}_{jj} & {R}_{kj} \\ {R}_{jk} & {R}_{kk}\end{matrix} ] = [ \begin{matrix}{R}_{j} {R}_{j}^{H} & 0 \\ 0 & {R}_{k} {R}_{k}^{H}\end{matrix} ] + [ \begin{matrix}\sqrt{{KK}^{H}} & K \\ K & \sqrt{{K}^{H} K}\end{matrix} ] ,$$
wherein Rⱼₖ and Rₖⱼ each represents the sub-matrixes represented by the entries at the j^{th} column, the k^{th} row and the k^{th} column, the j^{th} row of the matrix R*R^{H} respectively, Rᵢ represents a correlation matrix between the antennas of the i^{th} node at the receiving end, 0 represents an all-zero matrix and K represents a matrix resulting from multiplying an all-one matrix with a phase-shifting matrix.

13. The simulation method of claim 11, wherein the wireless communication system is an indoor wireless communication system.

14. The simulation method of claim 11, wherein the nodes in a same confined space are regarded as being in the same area.

15. The simulation method of claim 11, wherein the nodes in a same personal local area network are regarded as being in the same area.
